(19) United States
(12) Patent Application Publication
(10) Pub. No.: US 2021/0081939 A1
(43) Pub. Date: Mar. 18, 2021

(54) VENDING MACHINE TRANSACTION SYSTEM

(71) Applicant: Carrier Corporation, Palm Beach Gardens, FL (US)

(72) Inventors: Adam Kuenzi, Silverton, OR (US); Jin Kim, Demarest, NJ (US)

(21) Appl. No.: 16/620,428

(22) PCT Filed: Jun. 7, 2018
(86) PCT No.: PCT/US2018/036369

§ 371 Date: Dec. 6, 2019

Related U.S. Application Data
(60) Provisional application No. 62/516,561, filed on Jun. 7, 2017.

(51) Int. Cl. G06Q 20/38; G06Q 20/32; G06Q 20/18; G07F 9/00; G07F 9/02

(52) U.S. Cl. CPC G06Q 20/38215; G06Q 20/322; G06Q 20/3276; G07F 9/026; G06Q 20/18; G07F 9/001; G07F 9/002; G06Q 20/3278

(57) ABSTRACT

A vending machine credentialing system includes a vending machine, a mobile device, and at least one remote server. The vending machine is constructed and arranged to dispense an offering. The mobile device is configured to wirelessly send an intent to purchase message associated with the offering. The at least one remote server is configured to receive the intent to purchase message, execute a vending payment application toward procurement of the offering, and execute a credentialing application upon successful procurement that generates a credential rights message wirelessly sent to the mobile device. The mobile device is configured to send the credential rights message to the vending machine for dispensing of the offering.

### BACKGROUND

The present disclosure relates to vending machine transaction systems, and more particularly, to a vending machine credentialing system and method of operation.

Traditionally, vending machines directly receive cash and may dispense change as part of a transaction to purchase a product or service. More recent vending machines may also support purchases using credit cards. Unfortunately, to support a credit card transaction, the vending machine must be on-line with a network that may incur costs for the merchant or vending machine owner. Moreover, such vending machines may be subject to payment card industry (PCI) controls and audits relative, for example, to a PCI Data Security Standard (DSS).

### BRIEF DESCRIPTION

A vending machine credentialing system according to one non-limiting, embodiment of the present disclosure includes a vending machine constructed and arranged to dispense an offering, a mobile device configured to wirelessly send an intent to purchase message associated with the offering and initiated by a user of the mobile device, and at least one remote server configured to receive the intent to purchase message, execute a vending payment application toward procurement of the offering, and generate a credential rights message wirelessly sent to the mobile device, wherein the mobile device is configured to send the credential rights message to the vending machine for dispensing of the offering.

Additionally to the foregoing embodiment, the vending machine is an off-line vending machine, and wherein the at least one remote server is configured to execute a credentialing application upon successful procurement that generates the credential rights message.

In the alternative or additionally thereto, in the foregoing embodiment, the offering is a service.

In the alternative or additionally thereto, in the foregoing embodiment, the offering is a product.

In the alternative or additionally thereto, in the foregoing embodiment, the mobile device is a smartphone.

In the alternative or additionally thereto, in the foregoing embodiment, the off-line vending machine includes a processor configured to execute a validation application for decoding the credential rights message to determine access rights by comparing with a data element associated with a location of the offering, and a computer storage medium configured to store the data element.

In the alternative or additionally thereto, in the foregoing embodiment, the remote server is cloud-based.

In the alternative or additionally thereto, in the foregoing embodiment, the mobile device and the off-line vending machine communicate via Bluetooth.

In the alternative or additionally thereto, in the foregoing embodiment, the validation application of the off-line vending machine is configured to initiate and wirelessly send a dispensed confirmation message to the mobile device.

In the alternative or additionally thereto, in the foregoing embodiment, the mobile device is configured to send the dispensed confirmation message to the at least one remote server for inventory tracking.

In the alternative or additionally thereto, in the foregoing embodiment, the intent to purchase message includes a site address associated with the off-line vending machine.

In the alternative or additionally thereto, in the foregoing embodiment, the intent to purchase message includes an offering address associated with the off-line vending machine.

In the alternative or additionally thereto, in the foregoing embodiment, the vending machine credentialing system includes a bar code indicative of the site address, wherein the mobile device is constructed and arranged to scan the bar code.

In the alternative or additionally thereto, in the foregoing embodiment, the off-line vending machine is configured to transmit an advertisement indicative of the site address and the mobile device is configured to receive the advertisement.

A method of operating a vending machine credentialing system according to another, non-limiting, embodiment includes initiating an intent to purchase message based on an offering from an off-line vending machine, conducting a transaction relative to the intent to purchase message by the remote server, sending a credential rights message from the remote server to a mobile device based on the transaction, sending the credential rights message from the mobile device to the off-line vending machine, validating the credential rights message by the off-line vending machine, and dispensing the offering by the off-line vending machine.

Additionally to the foregoing embodiment, the method includes tracking inventory of the off-line vending machine by the remote server.

In the alternative or additionally thereto, in the foregoing embodiment, the method includes sending a dispensed confirmation message from the off-line vending machine to the mobile device and sending the dispensed confirmation message from the mobile device to the remote server for inventory tracking.

In the alternative or additionally thereto, in the foregoing embodiment, the dispensed confirmation message includes a time of purchase.

In the alternative or additionally thereto, in the foregoing embodiment, the dispensed confirmation message includes maintenance data.

In the alternative or additionally thereto, in the foregoing embodiment, communications between the mobile device and the off-line vending machine is near field communications.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a diagram of a vending machine credentialing system as one, non-limiting, exemplary embodiment of the present disclosure;

FIG. 2 is a schematic of a vending machine of the vending machine credentialing system;

FIG. 3 is a schematic of a mobile device of the vending machine credentialing system; and

FIG. 4 is a flow chart illustrating a method of operating the vending machine credentialing system.

### DETAILED DESCRIPTION

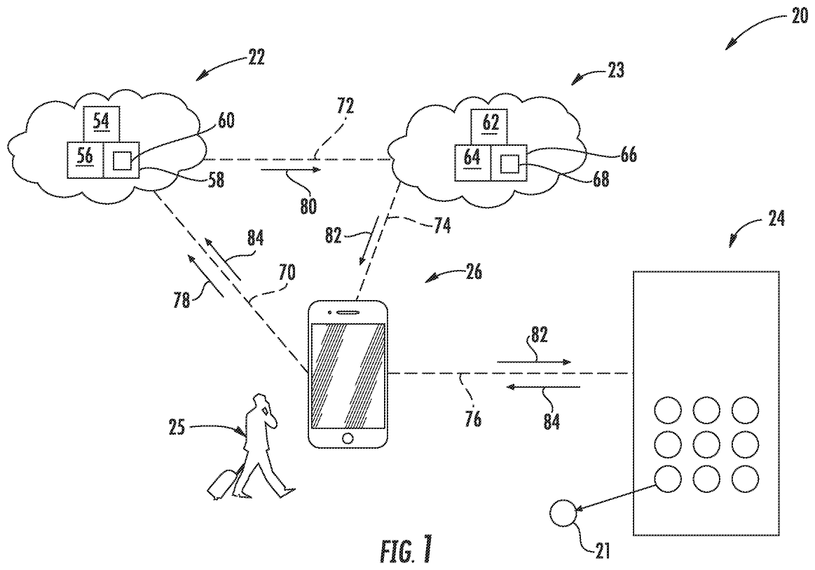

Referring to FIG. 1, a vending machine credentialing system 20 facilitates the purchase of an offering 21 by a user 25. The vending machine credentialing system 20 may include at least one remote server (i.e., two illustrated and identified as 22 and 23), a vending machine 24, and a mobile device 26 that may be carried about by the user 25. The offering 21 may be any service or product capable of being dispensed and/or conducted by the vending machine 24. Non-limiting examples of a dispensed service may include limited availability of hot water, heated or cooled air, a car wash, a user back massage, WiFi, spa, automotive parking, and other services. Non-limiting examples of a product may include edible snacks, drinks such as soda and coffee, and other products.

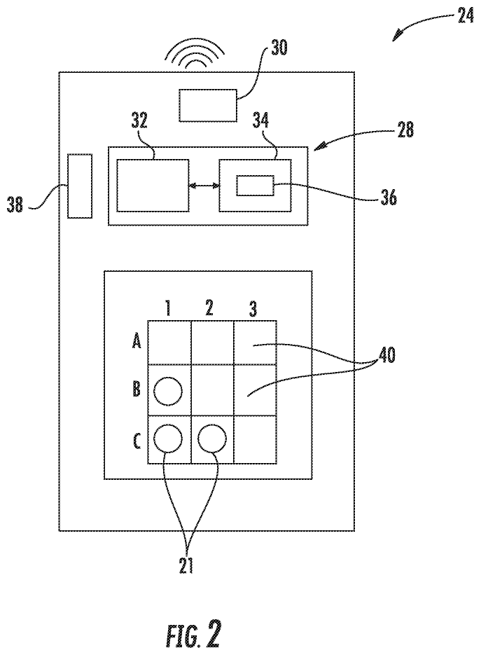

Referring to FIGS. 1 and 2, the vending machine 24 is constructed and arranged to produce and/or dispense the offering 21, and may include a controller 28 configured to at least control the machine 24, and a transceiver 30. The controller 28 may include a processor 32 (e.g., microprocessor) and a computer storage medium 34 that may be computer writeable and readable. The storage medium 34 may store any variety of electronic data including maintenance data or logs, and a user validation application or module 36 that may be software-based and executable by the processor 32. In one example, the vending machine 20 may further include a site address 38 associated with the specific machine 20 itself, and an offering address 40 (i.e., nine illustrated in FIG. 2). In the present example, and with nine offering addresses 40, the vending machine 24 may be capable of dispensing a variety of offerings 21 (i.e., up to nine) that may be snacks having different costs. For example, at offering address 40 identified visually on the machine 24 as “A1”, the machine 20 may dispense chips at a cost of $1.00. At offering address 40 identified visually on the machine 24 as “C3”, the machine 20 may dispense a candy bar at a cost of $1.25.

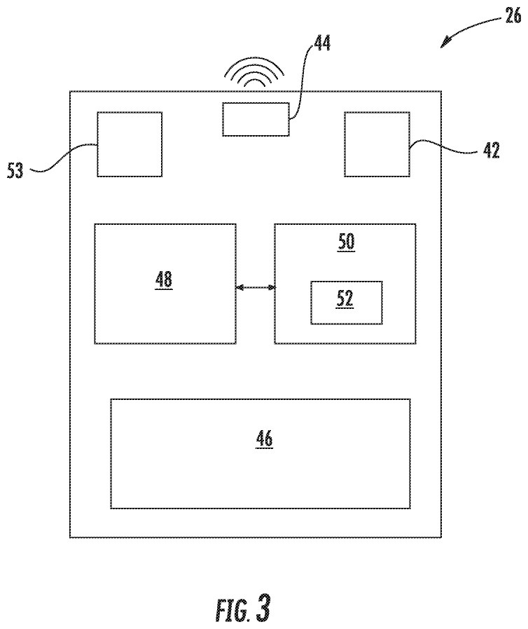

In one example, the site address 38 may be a barcode, QR code, or other code positioned to the vending machine 24 that may be scanned, or read, by the mobile device 26. In another example, the site address 38 may be wirelessly broadcast as an advertisement over a relatively short distance (e.g., Bluetooth® advertisement) that may be received and identified by the mobile device 26. In yet a third example, the mobile device 26 may identify a vending machine 24 based on the geographic location of the machine preprogrammed into either the remote server 22 and/or the mobile device 26, and use of a geographic positioning application 42 (see FIG. 3) applied by the mobile device 26.

The vending machine 24 may be an off-line vending machine in the sense that the vending machine does not need to be configured to directly receive internet (e.g., WiFi) or cellular phone service. Instead, the vending machine is capable of Near-Field Communications (NFC) or two-way Bluetooth communications at generally no monthly service cost to the owner(s) of the vending machine 24, or merchants associated with the vending machine. Instead, long range, wireless communications are fielded by the user 25 or owner of the mobile device 26, which is generally the purchaser of the vended offering 21.

Referring to FIGS. 1 and 3, the mobile device 26 may be a smartphone, a tablet, or other portable device that may be conveniently carried on the person of the user 25. The mobile device 26 may include a transceiver 44 for wireless communications, a user interface 46, a processor 48 (e.g., microprocessor) and a computer storage medium 50 that may be computer writeable and readable. The storage medium 50 may store a vending request application or module 52 that may be software-based and executable by the processor 48.

The vending request application 52 may be configured to identify the specific vending machine 24 that may be amongst a plurality of vending machines. In one example, the mobile device 26 may be configured to visually read the site address 38 as a bar code using a scanning device or camera 53. In another embodiment, the mobile device 26 may be configured to receive the site address 38 as a wireless signal or short range advertisement. In yet a third example, the vending request application 52 may apply the geographic positioning application 42 of the mobile device 26 to generally determine the closest, applicable, vending machine 24.

In the embodiment where the site address 38 of the vending machine 24 is a short range advertisement (e.g., Bluetooth advertisement), the mobile device 26 may be programmed with compatible software. In one example, the vending machine 24, or controller 28, may include a Bluetooth device capable of transmitting the advertisement 38. Transceivers 30, 44 may be of a type to support Bluetooth® communications. Further, the site address 38 may be advertised with continual advertisements from the vending machine 24, and may be received by the mobile device 26 without the vending machine 24 knowing or recognizing that a mobile device 26 is nearby.

In the embodiment that applies the geographic position application 42 of the mobile device 26, the application 42 may be configured to determine positioning information indicative of a geographical position using one or more positioning systems or protocols of a type well known in the art, such as Global Positioning Systems (GPS), Global Navigation System (GLONASS), Global Navigation Satellite System (GNSS), Galileo, Long Range Navigation (LORAN), National Marine Electronics Association (NMEA), Trimble Standard Interface Protocol (TSIP), DELORME® EARTHMATE®, Rockwell PLGR Protocol, iBeacon®, and SIRF®, to name a few non-limiting examples. It will also be appreciated that the geographic position application 42 may include local, regional, or site-wide systems of a type well known in the art, such as radio frequency identification (RFID), infrared (IR), sensor networks, Wi-Fi-based positioning, and Ultra-Wideband (UWB) positioning systems, to name a few non-limiting examples. The application 42 may work in conjunction with the user validation application 36 of the vending machine 24, and geographic position application 42 may be a Global Positioning System (GPS) receiver circuit, or circuitry associated with other satellite navigation systems. In any case, the applications 42, 52 function to determine the position of the mobile device 26 relative to a known placement of the vending machine 24. It will also be appreciated that the positioning information may include types well known in the arts such as, geographic latitude and longitude, Universal Transverse Mercator (UTM) and Universal Polar Stereographic (UPS) coordinates, stereographic coordinates, geodetic height, Cartesian coordinates, and site address, to name a few non-limiting examples.

Referring further to FIG. 1, the remote servers 22, 23 may be cloud-based servers configured to communicate directly with the mobile device 26, but may not be configured to communicate directly with the vending machine 24. The remote server 22 may include a transceiver 54 for wireless communications, a processor 56 (e.g., microprocessor) and an electronic storage medium 58 that may be computer writeable and readable. The storage medium 58 may store a vending payment application or module 60 that may be software-based and executable by the processor 56. The remote server 22 may represent multiple systems or processors. For example, the server 22 may be telecommunication system(s) that provide the transceiver 54 and other networking components (not shown) communications between the mobile device 26 and vending payment application 60. In a similar manner, the remote server 23 may include a transceiver 62 for wireless communications, a processor 64 (e.g., microprocessor) and an electronic storage medium 66 that may be computer writeable and readable. The storage medium 66 may store a credentialing application or module 68 that may be software-based and executable by the processor 64.

With regard to communications between components of the vending machine credentialing system 20, a wireless pathway 70 extends between the mobile device 26 and the remote server 22. A wireless pathway 72 may extend between the remote server 22 and the remote server 23. A wireless pathway 74 extends between the remote server 23 and the mobile device 26, and a wireless pathway 76 extends between the mobile device 26 and the vending machine 24.

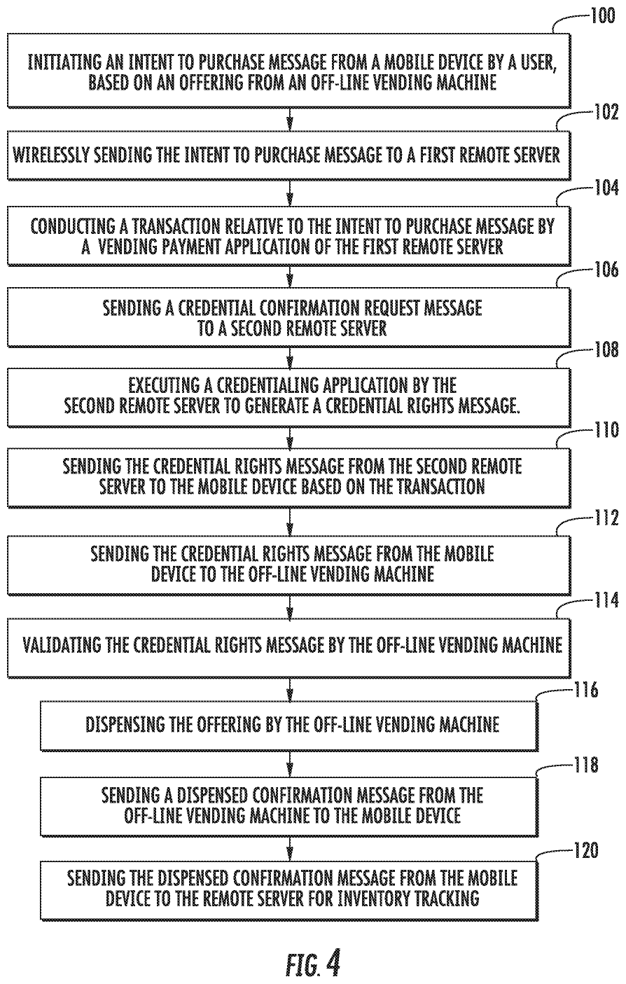

Referring to FIGS. 1 and 4, one, non-limiting, embodiment of a method of operating the vending machine credentialing system 20 is illustrated. At block 100, a user 25 may initiate an intent to purchase message (see arrow 78) from the user interface 46 of the mobile device 26, and based on an offering 21 from an off-line vending machine 24. The intent to purchase message 78 may include the site address 38 and the offering address 40 of the vending machine 24. At block 102, the intent to purchase message 78 may be wirelessly sent over pathway 70 to the remote server 22.

In another embodiment, the intent to purchase 78 may not include one or both of the site address 38 or the offering address 40 of the vending machine. Instead, the remote server 22 may determine the nearest vending machine 24 that supports an offering 21 and provides the site address 38 back to the mobile device 26 in response to message 78. Further, directions could be provided from the current location as determined by geographic positioning application 42 and presented on the display 46 to the user 25 so they can find the vending machine 24.

At block 104, the remote server 22 may execute the vending payment application 60. In one embodiment, the application 60 may include, or apply, a database that provides the cost of the offering 21. The actual method of payment may be any method known to one having skill in the art of payments, including cloud-based payment systems such as Apple Pay®, Paypal®, credit card data, direct withdrawals from banking accounts, token or credit based systems, and others. At block 106 and after the transaction is deemed successful by the vending payment application 60, the remote server 22 may send a credential confirmation request message (see arrow 80) over pathway 72, and to the remote server 23. At block 108, the remote server 23 executes the credentialing application 68 to generate a credential rights message (see arrow 82) relative to the site address 38 and offering address 40. At block 110, the remote server 23 may send the credential rights message 82 over pathway 74, and to the mobile device 26. It is contemplated and understood that the servers 22, 23 may, alternatively, be one, cloud-based, server having one processor capable of executing both applications 60, 68.

At block 112, the mobile device 26 may send the credential rights message 82 to the controller 28 of the vending machine 24. At block 114, the validation application 36 of the controller 28 may validate (i.e., decode) the credential rights message based on access rights data (i.e., a data element associated with a location of the offering) stored in the storage medium 34. The validation may include techniques well known in the art of encoding access rights including expiration of the credential, time-of-day limitations (e.g. for service offerings 21), one-time-use limitations or other types of limitations so that a user 25 is dispensed only the offering 21 they paid for. Additionally, the credential rights may precisely indicate securely which site address 38 and or offering address 40 of the offering 21 to dispense. Also, the validation may include verifying digital signatures, decrypting the access rights, or generally applying well known security techniques to securely validate that the access rights permit the user 25 to the offering 21 that is requested. At block 116, the offering 21 may be dispensed. Dispensing may occur via a manual action performed by the user, or may occur automatically as commanded by the controller 28.

At block 118, a dispensed confirmation message (see arrow 84) may be generated by the controller 28 of the vending machine 24 and sent over pathway 76 to the mobile device 26. The dispensed confirmation message 84 may indicate the successful dispensing of the offering 21, and may further include other information such as, for example, needed vending machine maintenance and time of dispensing of the offering 21, or backup battery status if the vending machine 24 includes a backup battery (not shown). At block 120, the dispensed confirmation message 84 may be sent by the mobile device 26, over pathway 70, and to the remote server 22. The remote server 22 may further be configured to track the successful dispensing of offerings 21 thereby maintaining inventory control to proper stock and maintain the vending machine 24.

The various functions described above may be implemented or supported by a computer program that is formed from computer readable program codes, and that is embodied in a computer readable medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other forms.

Terms used herein such as component, application, module, system, and the like are intended to refer to a computer-related entity, either hardware, a combination of hardware and software, or software execution. By way of example, an application may be, but is not limited to, a process running on a processor, a processor, an object, an executable, a thread of execution, a program, and/or a computer. It is understood that an application running on a server and the server, may be a component. One or more applications may reside within a process and/or thread of execution and an application may be localized on one computer and/or distributed between two or more computers.

Advantages and benefits of the present disclosure include an off-line vending machine that does not require on-line components or circuitry, and that can be deployed anywhere to reliably service customers with goods and services. Moreover, the vending machine credentialing system 20 does not require the use, or handling, of credit card information, therefore PCI concerns and monthly service charges may be eliminated.

While the present disclosure is described with reference to illustrated embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1-9. (canceled)

10. A vending machine credentialing system comprising:
a vending machine constructed and arranged to dispense an offering, the vending machine including a processor for processing at least a credential rights message;
a mobile device configured to wirelessly send an intent to purchase message associated with the offering; and
a server configured to receive the intent to purchase message, execute a vending payment application toward procurement of the offering, and generate the credential rights message wirelessly sent to the mobile device, wherein the mobile device is configured to send the credential rights message to the vending machine for dispensing of the offering, wherein the vending machine is an off-line vending machine, the server is configured to execute a credentialing application upon successful procurement that generates the credential rights message, the validation application of the off-line vending machine is configured to initiate and wirelessly send a dispensed confirmation message to the mobile device, and the mobile device is configured to send the dispensed confirmation message to the server for inventory tracking.

11. A vending machine credentialing system comprising:
a vending machine constructed and arranged to dispense an offering, the vending machine including a processor for processing at least a credential rights message;
a mobile device configured to wirelessly send an intent to purchase message associated with the offering; and
a server configured to receive the intent to purchase message, execute a vending payment application toward procurement of the offering, and generate the credential rights message wirelessly sent to the mobile device, wherein the mobile device is configured to send the credential rights message to the vending machine for dispensing of the offering, wherein the vending machine is an off-line vending machine, and wherein the server is configured to execute a credentialing application upon successful procurement that generates the credential rights message, and the intent to purchase message includes a site address associated with the off-line vending machine.

12. The vending machine credentialing system set forth in claim 11, wherein the intent to purchase message includes an offering address associated with the off-line vending machine.

13. The vending machine credentialing system set forth in claim 11 further comprising:
a bar code indicative of the site address, wherein the mobile device is constructed and arranged to scan the bar code.

14. The vending machine credentialing system set forth in claim 11, wherein the off-line vending machine is configured to transmit an advertisement indicative of the site address and the mobile device is configured to receive the advertisement.

15. A method of operating a vending machine credentialing system comprising:
initiating an intent to purchase message based on an offering from an off-line vending machine;
conducting a transaction relative to the intent to purchase message by a server;
sending a credential rights message from the server to a mobile device based on the transaction;
sending the credential rights message from the mobile device to the off-line vending machine;
validating the credential rights message by the off-line vending machine;
dispensing the offering by the off-line vending machine; and
tracking inventory of the off-line vending machine by the server.

16. (canceled)

17. The method set forth in claim 15, further comprising:
sending a dispensed confirmation message from the off-line vending machine to the mobile device; and
sending the dispensed confirmation message from the mobile device to the server for inventory tracking.

18. The method set forth in claim 17, wherein the dispensed confirmation message includes a time of purchase.

19. The method set forth in claim 18, wherein the dispensed confirmation message includes maintenance data.

20. The method set forth in claim 15, wherein communications between the mobile device and the off-line vending machine is Near-Field Communications.
